(19) United States
(12) Patent Application Publication
(10) Pub. No.: US 2010/0284865 A1
(43) Pub. Date: Nov. 11, 2010

(54) GENERATOR OF HYDROGEN-ABUNDANT WATER IN THE SHAPE OF A TORPEDO

(76) Inventor: Hitoshi Sugawara, Stockton, CA (US)

Correspondence Address: Hitoshi Sugawara, 7827 Thornton Road, Stockton, CA, 95207-3064, US

(21) Appl. No.: 12/547,479

(22) Filed: Aug. 26, 2009

Related U.S. Application Data
(60) Provisional application No. 61/176,386, filed on May 7, 2009.

(51) Int. Cl. C01B 3/02; C01B 5/00

(52) U.S. Cl. 422/162; 423/648.1

(57) ABSTRACT

A torpedo-shaped, flexible wing-equipped, hydrogen generator is disclosed, comprising a case filled with magnesium and other natural mineral grains which produces hydrogen-abundant water without electrolysis. The generation of hydrogen is effected by a simple, natural chemical reaction between water and magnesium. The hallmark of this invention is the flexible wing component, which solves two major problems of current hydrogen generators: slippage and water flow obstruction. By nature of its design, the wings act as a stopper to prevent the hydrogen generator from slipping out of an inverted PET water bottle.

### BACKGROUND OF THE INVENTION

The present invention relates to a hydrogen generator containing magnesium, which chemically reacts with water to generate hydrogen without electrolysis. The hydrogen generator is designed in a torpedo-shape, and includes a flexible wing component which serves as a measure to overcome the limitations of hydrogen generators currently on the market.

A major problem with hydrogen generators on the market today is that by nature of their smooth, cylindrical shape, they easily slip or fall out of an inverted PET water bottle. To counteract that problem, a user must block the PET bottle opening with a finger while pouring from the bottle. However, that measure is inconvenient, impractical, and in turn causes further water flow obstruction. On the other hand, when a user drinks directly from the PET bottle, the hydrogen generator falls out, colliding with a user's teeth or lips. In the case of a child, the hydrogen generator could conceivably slip into and lodge in a child's throat, leading to choking.

It is known in the prior art the disclosure of a method of producing hydrogen rich water as well as a hydrogen rich water generator. However, the prior art fails to address any type of hydrogen-generator which includes a wing component as a means to prevent stick slippage and water flow obstruction.

The present invention offers a significant improvement in safety and practicality over current hydrogen generators by integrating a flexible wing component on one end of the case. The wings prevent the hydrogen generator from slipping through the neck of a water bottle, while simultaneously permitting a free flow of water.

### SUMMARY OF THE INVENTION

The present invention is a hydrogen generator in the shape of a torpedo, with an innovative flexible wing component. When compressed, the flexible wings can pass through the neck of a typical 500-ml PET water bottle. Once inside, the wings expand to their normal configuration. Usage of a hydrogen generator involves inversion of a PET bottle, and the law of gravity is inevitable. The wing component, by serving as a “catch”, offers several advantages: 1) it prevents the hydrogen generator from falling out and jarring a user's teeth or lips; thereby avoiding pain and annoyance; 2) it prevents the hydrogen generator from dropping out to the ground; thereby avoiding breakage and/or contamination; 3) it prevents the hydrogen generator from slipping into and lodging in a child's throat, thereby avoiding the risk of airway obstruction and choking to death; 4) it prevents the hydrogen generator from getting jammed in the neck of the PET bottle; thereby preventing a blockage of water flow; 5) it obviates a user's need to push their finger into the PET bottle opening to hold the hydrogen generator in place while pouring; thereby avoiding inconvenience and water contamination.

### DESCRIPTION OF DRAWINGS

FIG. 1 is an explanatory drawing of the present invention in an upright water bottle.

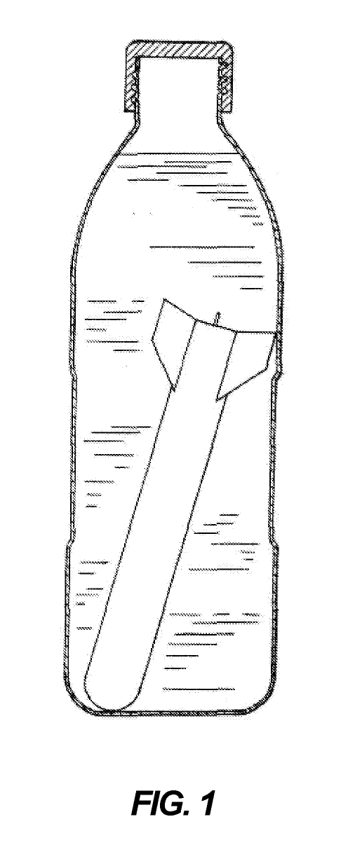

FIG. 2 is an explanatory drawing of the present invention in an inverted water bottle.

FIG. 3 is a drawing of the present invention with integrated flexible wing component.

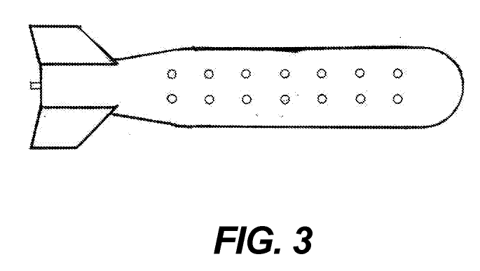

FIG. 4 includes explanatory and cross-sectional drawings of the present invention and flexible wing component.

### DETAILED DESCRIPTION OF THE INVENTION

The invention is a generator of hydrogen-abundant water, comprising a body and flexible wing component as a single unit. The body includes holes to allow for passage of hydrogen gas. One end of the body has a removable cap. Inside the body is an admixture of hydrogen-generating minerals, comprising primarily magnesium and other natural mineral grains. A mesh bag is used to contain the magnesium and mineral grains inside the case. The wing is the key element of the invention, because without it, the hydrogen generator would fall out of an inverted water bottle. The wing is attached to the “tail” end of the hydrogen generator, giving an overall appearance of a torpedo.

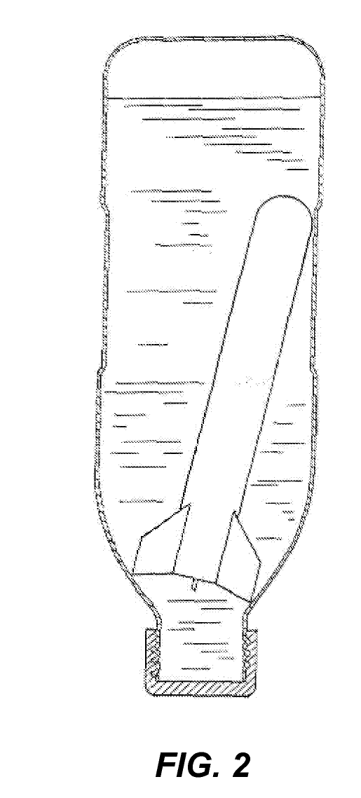

The invention creates hydrogen-abundant water in a safe, practical, appealing torpedo design which simultaneously obviates problems of slippage and water flow obstruction as occurs with currently marketed hydrogen generator sticks. The hallmark wing feature prevents the hydrogen generator from falling out of an inverted water bottle (FIG. 2), while also permitting an unobstructed flow of water when pouring.

The invention would be produced using injection-molding technology to create the external body and wings of the hydrogen generator. The manufacturing process would include filling a fine mesh bag with the admixture of magnesium and other mineral grains. The bag is sewn closed, inserted into the body, and the entire case sealed by an end cap on the head portion of the torpedo.

To use this hydrogen generator, it is immersed in a bottle of water, most commonly a 500-ml size PET bottle. The flexible wings are compressed to fit through the neck of the bottle. When a user inverts the water bottle to drink or pour, the wings will “catch” the lower inner mouth of the bottle, thus preventing the hydrogen generator from falling out.

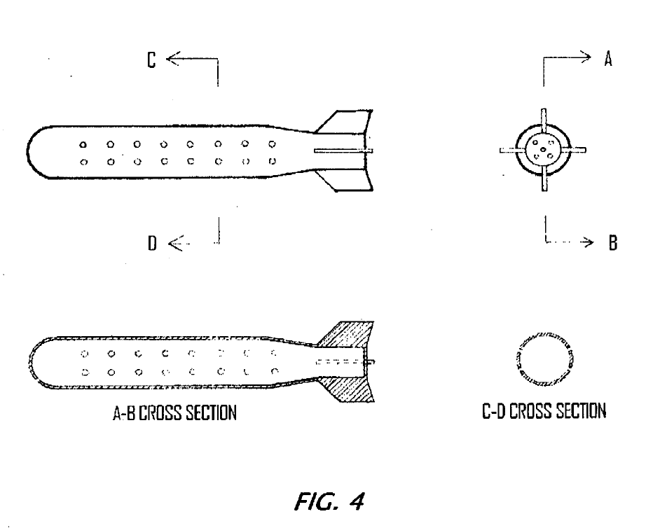

With reference to the drawings and, in particular, with reference to FIG. 4, the hydrogen generator comprises a torpedo-shaped body portion and a tail portion with an integrated wing component. The body, preferably made of a plastic or resin material, is defined by an outer shell (1), outlet holes (5), and a wing component at the tail end (B), comprising blades (2, 3, and 4). FIG. 4 also contains cross-sectional drawings, where A-B and C-D represent cross sections of the hydrogen generator.

The body includes a plurality of holes (FIG. 4, #5) to allow for passage of hydrogen gas. The exact length and diameter of the body may vary. The case of the hydrogen generator contains a magnesium and mineral grain admixture within a mesh bag, which generates hydrogen-abundant water when the entire generator is immersed in plain water. The end of the body opposite the wing has a removable cap, which is snapped in place after the case is filled with the internal mineral grain admixture.

The wing component is attached to the tail end of the body. It is preferably comprised of a flexible plastic or resin material. The size and style of the wings may vary. Preferably, the wings are designed like the blades of a real torpedo, and will have preferably two to four blades. The wings may also be designed in different variations (pins, fish fins, ball-on-stick, flower petal, starfish, finger-like) as long as the unfurled wing component serves to prevent the hydrogen generator from slipping out of an inverted PET bottle.

The flexible wings are squeezed to pass through the neck of a water bottle. Inside the bottle, the flexible wings return to their original form. When a water bottle is inverted, the hydrogen generator's wing tips will contact the lower inner rim (FIG. 2), preventing the generator from slipping out. Additionally, the wing design permits a free flow of water, thereby avoiding water obstruction at the neck of the bottle.

Although the invention has been described in connection with a preferred embodiment, it should be understood that various modifications, additions and alterations may be made to the invention by one skilled in the art without departing from the spirit and scope of the invention as defined in the appended claims.

What is claimed is:

1. A torpedo-shaped hydrogen generator comprising a resin case with a flexible wing component, containing an internal admixture of magnesium and other natural mineral grains to produce hydrogen-abundant water.

2. The hydrogen generator recited in claim 1 wherein said case is fabricated of a resin material, comprising a plurality of holes to serve as hydrogen outlets.

3. The hydrogen generator recited in claim 1 wherein said case includes a flexible wing component in the design of torpedo blades or other similar projections which prevent slippage from the opening of a water bottle.
